(19) United States
(12) Patent Application Publication
(10) Pub. No.: US 2006/0147203 A1
(43) Pub. Date: Jul. 6, 2006

(54) Optical network element with remote access capability

(76) Inventor: Arthur Martin Thinguldstad, Raleigh, NC (US)

Correspondence Address: ALCATEL USA;INTELLECTUAL PROPERTY DEPARTMENT, 3400 W. PLANO PARKWAY, MS LEGL2, PLANO, TX, 75075, US

(21) Appl. No.: 11/026,196

(22) Filed: Dec. 30, 2004

(51) Int. Cl. H04B 10/08

(52) U.S. Cl. 398/9

(57) ABSTRACT

An Optical Network Terminal (ONT) for a Passive Optical Network (PON) system comprises a Diagnostic Interface Support Functions (DISF) module and a PON Interface Support Functions (PISF) module connected to the DISF module. The PISF module is configured for receiving a remotely-issued diagnostic request transmitted for reception by the PISF module over a PON connected to the PISF module and for transmitting request reply information over the PON from the PISF module in response to the PISF module receiving the request reply information from the DISF module. The DISF module and the PISF module are jointly configured for enabling the remotely-issued diagnostic request to be communicated from the PISF module to the DISF module and for enabling the request reply information to be communicated from the DISF module to the PISF module.

### FIELD OF THE DISCLOSURE

The disclosures made herein relate generally to Passive Optical Network systems and more particularly to facilitating remote access to Optical Network Terminal diagnostic functionalities.

### BACKGROUND

In a Passive Optical Network (PON) system, an Optical Line Terminal (OLT) resides at a Central Office (CO) location and an Optical Network Terminal (ONT) resides at a service subscriber location. These two network elements interoperate to facilitate data transmission between the CO and the service subscriber location. The OLT and the ONT have respective local diagnostic interfaces for providing personnel (i.e., a craftsperson) with local access to diagnostic functionalities. An Element Management System (EMS) is connected to the OLT via a respective interface channel, enabling certain diagnostic functionalities of the OLT and ONT to be facilitated over the PON via the EMS. Examples of such diagnostic functionalities include, but are not limited to, one or more of functionalities relating to system maintenance, functionalities relating to system testing and functionalities relating to system provisioning.

When desired ONT diagnostic functionalities are supported by ONT management and control interface (OMCI), their activation can be facilitated remotely via the resident interface of the OLT or via the Element Management System. However, accessing ONT diagnostic functionalities that are not supported by one or more communications channels, interfaces and/or network elements (e.g., an ONT management and control interface (OMCI)) requires physical connection to the local ONT diagnostic interface (i.e., the local craft interface). Such a situation of non-supported ONT diagnostic functionality means that a craftsperson must travel to the physical location where the ONT is installed to access these diagnostic functionalities.

Accessing ONT diagnostic functionalities locally at an ONT is expensive, potentially dangerous and logistically inefficient. Each truck roll to a service subscriber location represents a significant expense to a telecommunications company. Additionally, access to the ONT may not be possible without physical access to the subscriber's home or business, which can lead to further expense due to wait time and/or return trips.

Therefore, an approach for facilitating access to ONT diagnostic functionalities in a manner that overcomes drawbacks associated with conventional approaches for facilitating access to ONT diagnostic functionalities would be advantageous, useful and novel.

### SUMMARY OF THE DISCLOSURE

The inventive disclosures made herein enable access to ONT diagnostic functionalities to be facilitated in a manner that overcomes shortcomings associated with conventional approaches for accessing ONT diagnostic functionalities. More specifically, embodiments of systems and methods in accordance with the inventive disclosures made herein allow ONT diagnostic functionalities that are not supported by a standard ONT management and control interface protocol (i.e., proprietary diagnostic functionalities) to be accessed not only locally at an ONT, but also remotely via a corresponding OLT or EMS. Accordingly, except for perhaps the most extreme situations (e.g., those required to address ONT/OLT communications at the PON level), embodiments of systems and methods in accordance with the inventive disclosures made herein will eliminate the need to travel to the physical location of the ONT. The advantages of these systems and methods allowing remote access to such non-interface supported ONT diagnostic functionalities include, but are not limited to, reducing expenses associated with truck roll to a service subscriber location, reducing expenses associated with wait time at and/or return trips to the service subscriber location and reducing risk to the craftsperson from situations that may exist at the service subscriber location.

In accordance with one embodiment of the inventive disclosures made herein, an Optical Network Terminal (ONT) for a Passive Optical Network (PON) system comprises a Diagnostic Interface Support Functions (DISF) module and a PON Interface Support Functions (PISF) module connected to the DISF module. The PISF module is configured for receiving a remotely-issued diagnostic request transmitted for reception by the PISF module over a PON connected to the PISF module and for transmitting request reply information over the PON from the PISF module in response to the PISF module receiving the request reply information from the DISF module. The DISF module and the PISF module are jointly configured for enabling the remotely-issued diagnostic request to be communicated from the PISF module to the DISF module and for enabling the request reply information to be communicated from the DISF module to the PISF module.

In accordance with another embodiment of the inventive disclosures made herein, a passive optical network system comprises an Optical Network Terminal (ONT), an Optical Line Terminal (OLT) and a Passive Optical Network (PON) connected between the ONT and the OLT. The ONT and the OLT are jointly configured for enabling a remotely-issued diagnostic request to be communicated from the OLT to the ONT via the PON. The ONT and the OLT are jointly configured for enabling request reply information to be communicated from the ONT to the OLT over the PON. The ONT and the OLT each include a Diagnostic Interface Support Functions (DISF) module and a PON Interface Support Functions (PISF) module. The DISF module of the OLT and the PISF module of the OLT are jointly configured for enabling the remotely-issued diagnostic request to be communicated from the DISF module of the OLT to the PISF module of the OLT and for enabling the request reply information to be communicated from the PISF module of the OLT to the DISF module of the OLT. The DISF module of the ONT and the PISF module of the ONT are jointly configured for enabling the remotely-issued diagnostic request to be communicated from the PISF module of the ONT to the DISF module of the ONT and for enabling the request reply information to be communicated from the DISF module of the ONT to the PISF module of the ONT.

In accordance with one embodiment of the inventive disclosures made herein, a method for facilitating remote access of Optical Network Terminal (ONT) functionalities in a Passive Optical Network (PON) system is provided. The method includes facilitating transmission of an ONT diagnostic functionality request from an Optical Line Terminal (OLT) for reception by an ONT over a PON connected between the ONT and the OLT. In response to receiving the request and recognizing the request as being transmitted from the OLT, implementation of the ONT diagnostic functionality is facilitated for determining a diagnostic result. After facilitating implementation of the ONT diagnostic functionality, transmission of request reply information from the ONT for reception by the OLT is facilitated. The request reply information corresponds to the diagnostic result.

In accordance with one embodiment of the inventive disclosures made herein, a method for facilitating remote access of Optical Network Terminal (ONT) functionalities in a Passive Optical Network (PON) system is provided. The method includes receiving a remotely-issued diagnostic request transmitted for reception by a PON Interface Support Function (PISF) module of an ONT over a PON connected to the PISF, communicating the remotely-issued diagnostic request from the PISF module to a Diagnostic Interface Support Functions (DISF) module of the ONT and communicating request reply information from the DISF module to the PISF module. In response to the PISF module receiving the request reply information from the DISF module, the request reply information is transmitted over the PON from the PISF module.

These and other objects and embodiments of the inventive disclosures made herein will become readily apparent upon further review of the following specification and associated drawings.

### BRIEF DESCRIPTION OF THE DRAWING FIGURES

FIG. 1 depicts an embodiment of a passive optical network system in accordance with an embodiment of the inventive disclosures made herein

FIG. 2 depicts an embodiment of the optical line terminal depicted in FIG. 1.

FIG. 3 depicts an embodiment of the optical network terminal depicted in FIG. 1.

FIGS. 4A through 4C depict a method for facilitating optical network terminal diagnostic functionality in accordance with the invention disclosures made herein.

### DETAILED DESCRIPTION OF THE DRAWING FIGURES

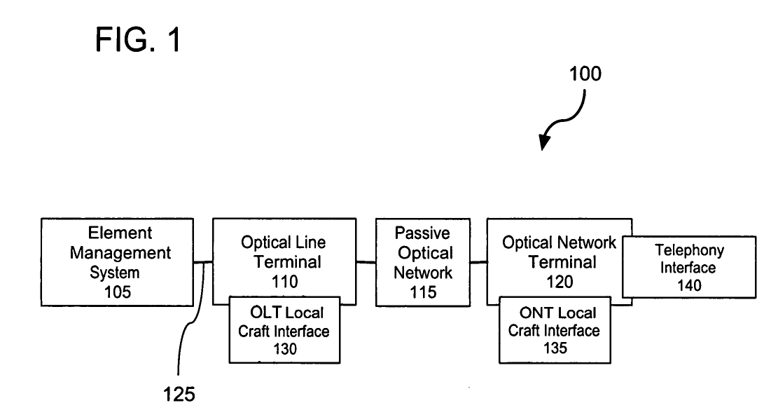

FIG. 1 depicts an embodiment of a Passive Optical Network (PON) system 100 in accordance with an embodiment of the inventive disclosures made herein. From a hardware configuration standpoint, the PON system 100 is preferably, but not necessarily, configured generally according to the configuration of a conventional PON system. However, from a software/methodology standpoint, the PON system 100 is configured for carrying out ONT diagnostic functionality in accordance with the inventive disclosures made herein.

The PON system 100 includes an Element Management System (EMS) 105, an Optical Line Terminal (OLT) 110, a PON 115 and an Optical Network Terminal (ONT) 120. The EMS 105 is connected to the OLT 110 via an Element Management Channel (EMC) 125, thereby enabling communication therebetween. The OLT 110 is connected to the ONT 120 via the PON 115, thereby enabling communication therebetween.

The EMS 105 is configured for providing remote management access to the OLT 110, the PON 115 and the ONT 120. The OLT 110 includes an OLT local craft interface 130 (e.g., a TL1 interface), thereby providing a local interface for a craftsperson. The OLT 110 is configured for facilitating required diagnostic functionalities to provide PON capabilities, for providing an interface with the EMS 105 and for providing remote management access to the EMS 105, the PON 115 and the ONT 120. The PON 115 provides optical connectivity between the OLT 110 and the ONT 120. The ONT 120 is deployed in geographically any one of diverse locations on a service subscriber's property, including within a residence or business building. The ONT 120 includes an ONT local craft interface 135 and a telephony interface 140. The ONT local craft interface 135 provides for a local interface for a craftsperson and the telephony interface 140 provides for connectivity with service subscriber equipment.

In accordance with the inventive disclosures made herein, at least a portion of the diagnostic capabilities accessible at the ONT craft interface 135 is proprietary and not supported (i.e., non supported ONT diagnostic functionality) by PON interface capabilities of the ONT 120. In accordance with the inventive disclosures made herein, the ONT 120 along with the EMS 105 and/or the OLT 110 are configured for enabling a craftsperson to facilitate such non-supported diagnostic functionalities via the EMS 105 and/or the OLT local craft interface 130. To enable access to such non-supported diagnostic functionalities via the EMS 105, the EMS 105 is configured to provide access to the OLT capabilities that enable ONT diagnostic functionality in accordance with the inventive disclosures made herein. In one embodiment, the EMS 105 includes a graphical user interface that provides a craftsperson with the capability to establish a remote session on the ONT for implementing such non-supported diagnostic functionalities and with capability to interact directly with the processor in the ONT to access the hardware and/or software registers that are used by other software in the ONT. As described in greater detail below, the OLT 110 and the ONT 120 are configured for enabling non-supported diagnostic functionality to be carried out in accordance with the inventive disclosures made herein.

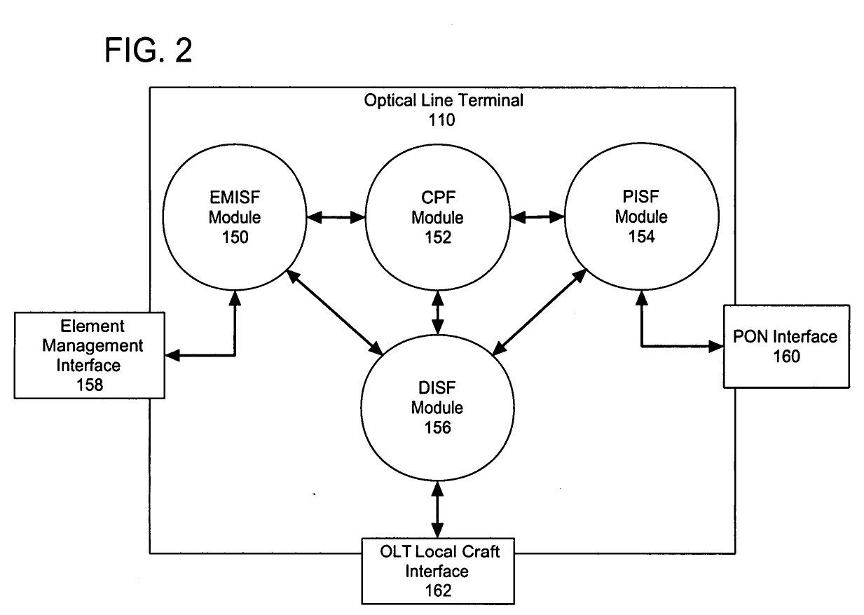

FIG. 2 depicts an embodiment of the OLT 110. The OLT 110 includes an Element Management Interface Support Functions (EMISF) module 150, a Core Processing Functions (CPF) module 152, a PON Interface Support Functions (PISF) module 154 and a Diagnostic Interface Support Functions (DISF) module 156. The EMISF module 150, the CPF module 152, the PISF module 145 and the DISF module 156 (i.e., functional blocks of the OLT 110) are interconnected for enabling interaction therebetween. The EMISF module 150 of the OLT 110 comprises the hardware and/or software that support an element management interface 158 of the OLT 110 for enabling communication of information over the EMC 125 (depicted in FIG. 1). The PISF module 154 of the OLT 110 comprises the hardware and/or software that support a PON interface 160 of the OLT 110 for enabling communication of information over the PON 115 (depicted in FIG. 1). The DISF module 156 of the OLT 110 comprises the hardware and/or software that support the OLT local craft interface 162 of the OLT 110 for enabling communication of information via diagnostic equipment operated by a craftsperson. The CPF module 152 of the OLT 110 comprises the hardware and/or software (e.g., data processing devices power supplies, hardware monitoring functions, etc) that are not directly related to the support of any of the physical interfaces (e.g., the EMS interface 148, the PON interface 160 and the OLT local craft interface 162) supported by the OLT 110.

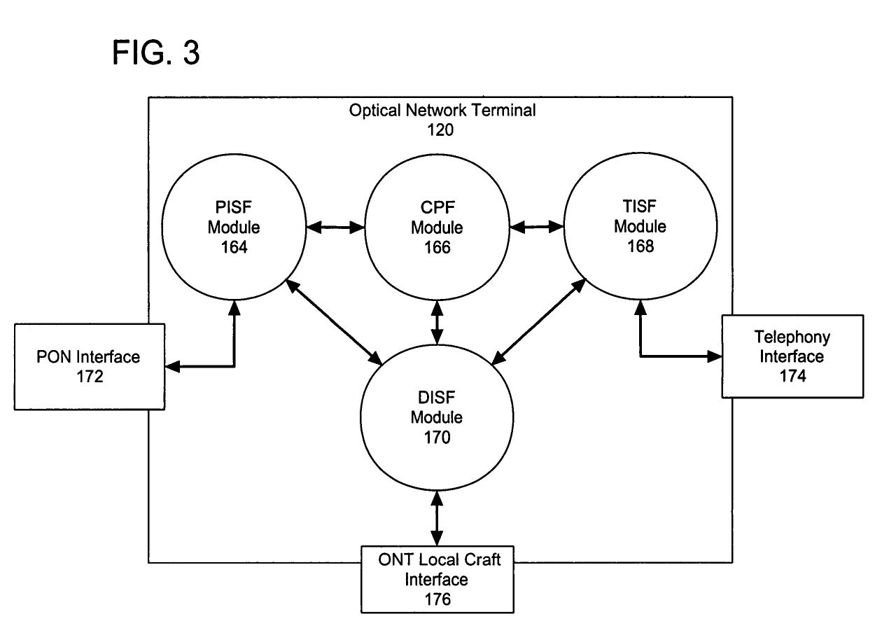

FIG. 3 depicts an embodiment of the ONT 120 of FIG. 1. The ONT 120 includes a PISF module 164, a Core Processing Functions (CPF) module 166, a TISF module 168 and a DISF module 170. The PISF 164, the CPF module 166, the TISF module 168 and the DISF module 170 (i.e., functional blocks of the ONT 120) are interconnected for enabling interaction therebetween. The PISF module 164 of the ONT 120 comprises the hardware and/or software that support a PON interface 172 of the ONT 120 for enabling communication of information over the PON 115 (depicted in FIG. 1). The TISF module 168 of the ONT 120 comprises the hardware and/or software that support a telephony interface 174 of the ONT 120 for enabling communication of information with subscriber equipment via an interface channel at the service subscriber's premises. The DISF module 170 of the ONT 120 comprises the hardware and/or software that support the ONT local craft interface 176 for enabling communication of information via diagnostic equipment operated by a craftsperson. The CPF module 166 of the ONT 120 comprises the hardware and/or software (e.g., data processing devices power supplies, hardware monitoring functions, etc) that are not directly related to the support of any of the physical interfaces (e.g., PON interface 172, the telephony interface 174 and the ONT local raft interface 176) supported by the ONT 120.

Accordingly, an OLT in accordance with the inventive disclosures made herein provides transport functionality for information and an ONT in accordance with the inventive disclosures made herein provides transport functionality, request interpretation functionality and request implementation functionality. Through the functionalities provided by the OLT and the ONT in accordance with the inventive disclosures made herein, a craftsperson is able to diagnose ONT problems remotely (e.g., from the OLT and/or an EMS), even if the OLT and the ONT are build by different companies and do not fully support the respective diagnostic functionality of each other. For example, by utilizing a user-defined message that specifies a desired diagnostic functionality request and that the OLT recognizes and communicates to the ONT, the OLT provides a transport mechanism for message content between the craftsperson and the ONT, thereby enabling the ONT to receive, recognize and interpret requested diagnostic functionality of the user-defined message.

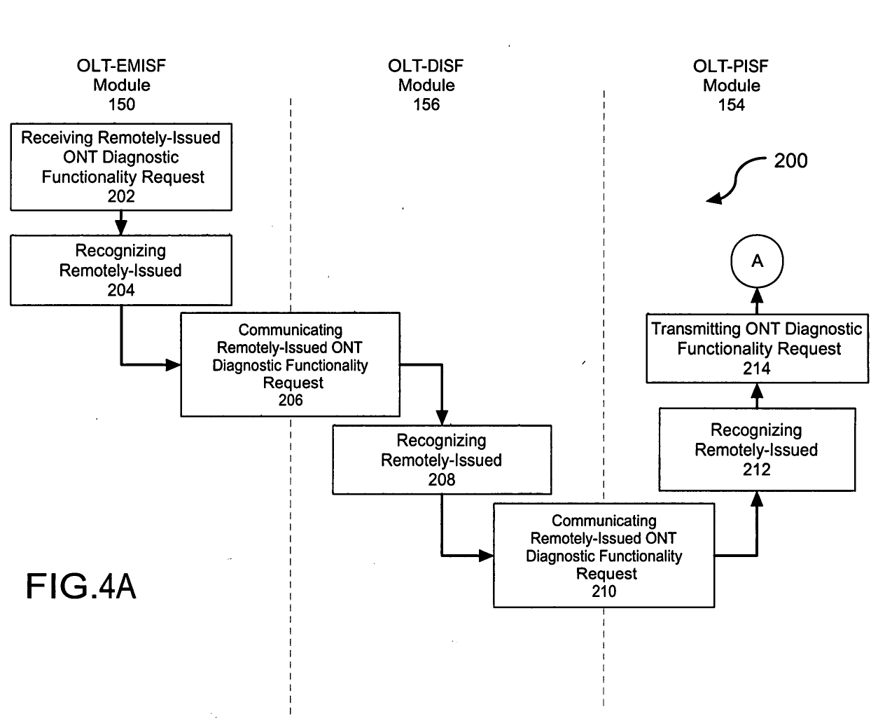

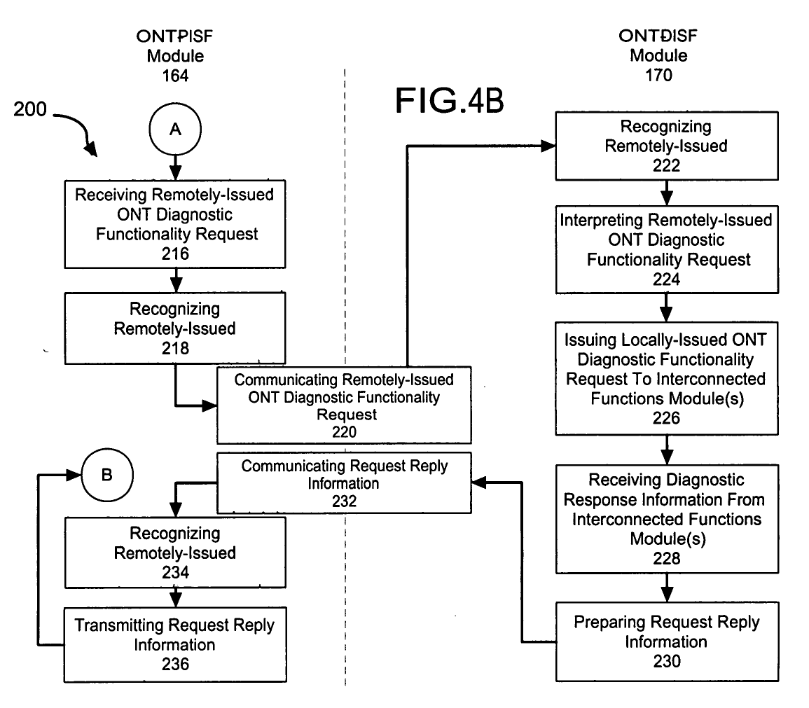

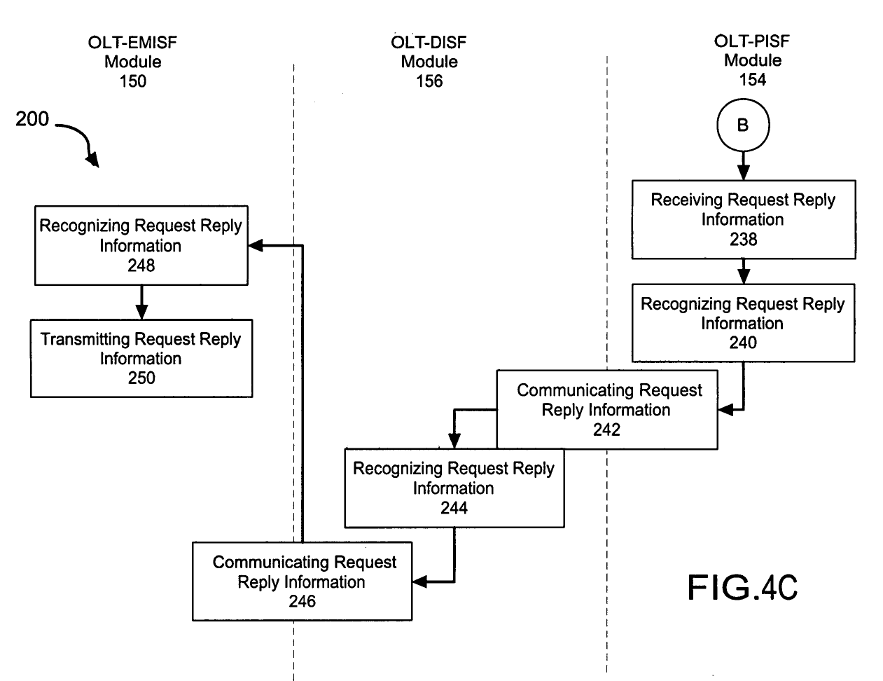

FIGS. 4A through 4C depict a method 200 for facilitating ONT diagnostic functionality in accordance with the invention disclosures made herein. Accordingly, the method 200 is configured for enabling ONT diagnostic functionalities that are not supported by a standard ONT management and control interface protocol (i.e., proprietary diagnostic functionalities) to be accessed locally at an ONT and, advantageously, remotely over a PON via a corresponding OLT or EMS. Accordingly, except for perhaps the most extreme situations (e.g., those required to address ONT/OLT communications at the PON level), the method 200 eliminates the need for a craftsperson to travel to the physical location of the ONT, thereby reducing expenses associated with truck roll to a service subscriber location, reducing expenses associated with wait time at and/or return trips to the service subscriber location and reducing risk to the craftsperson from situations that may exist at the service subscriber location. The PON system 100 and constituent network elements depicted in FIGS. 1 through 3 is an example of hardware configurable (i.e., through software and/or methodology modifications) for carrying out the method 100. For clarity, the operations comprised by the method 200 will be described in combination with the constituent network elements of the PON system 100. However, it will be understood by a skilled person that implementation of the functionality tangibly embodied by the method 100 is not limited to implementation via the PON system 100 and its constituent network elements.

Referring to FIG. 4A, the EMISF module 150 of the OLT 110 performs an operation 202 for receiving a remotely-issued ONT diagnostic functionality request, which is transmitted from the EMS 105 for reception by the OLT 110. In response to receiving remotely-issued ONT diagnostic functionality request, the EMISF module 150 of the OLT 110 performs an operation 204 for recognizing the remotely-issued ONT diagnostic functionality request. Such recognition in the downstream direction (i.e., toward the ONT 120) is disclosed herein to be recognition that the remotely-issued ONT diagnostic functionality request corresponds to non-supported ONT diagnostic functionality and thus must be interpreted, communicated, transmitted, received and/or implemented using methodologies in accordance with the inventive disclosures made herein. For example, in one embodiment, the step of recognizing the remotely-issued ONT diagnostic functionality request includes comparing the remotely-issued ONT diagnostic functionality request against a collection of known requests for non-supported ONT diagnostic functionality.

In response to recognizing the remotely-issued ONT diagnostic functionality request as being a request for implementing non-supported ONT diagnostic functionality, the EMISF module 150 of the OLT 110 and the DISF module 156 of the OLT 110 jointly perform an operation 206 for communicating the remotely-issued ONT diagnostic functionality request from the EMISF module 150 of the OLT 110 to the DISF module 156 of the OLT 110. In response to the remotely-issued ONT diagnostic functionality request being communicated to the DISF module 156 of the OLT 110, the DISF module 156 of the OLT 110 performs an operation 208 for recognizing the remotely-issued ONT diagnostic functionality request. In response to recognizing the remotely-issued ONT diagnostic functionality request as being a request for implementing non-supported ONT diagnostic functionality, the DISF module 156 of the OLT 110 and the PISF module 154 of the OLT 110 jointly perform an operation 210 for communicating the remotely-issued ONT diagnostic functionality request from the DISF module 156 of the OLT 110 to the PISF module 154 of the OLT 110. In response to the remotely-issued ONT diagnostic functionality request being communicated to the PISF module 154 of the OLT 110, the PISF module 154 of the OLT 110 performs an operation 210 for recognizing the remotely-issued ONT diagnostic functionality request. In response to recognizing the remotely-issued ONT diagnostic functionality request as being a request for implementing non-supported ONT diagnostic functionality, the PISF module 154 performs an operation 214 for transmitting the remotely-issued ONT diagnostic functionality request from the OLT 110 for reception by the ONT 120 over the PON 115. In one embodiment, transmitting the remotely-issued ONT diagnostic functionality request preferably includes generating one or more command packets corresponding to the requested ONT diagnostic functionality and being configured for transmission over the PON 115.

Referring to FIG. 4B, the PISF module 164 of the ONT 120 performs an operation 216 for receiving the remotely-issued ONT diagnostic functionality request, which was transmitted from the OLT 110 for reception by the ONT 120. In response to receiving the remotely-issued ONT diagnostic functionality request, the PISF module 164 of the ONT 120 performs an operation 218 for recognizing the remotely-issued ONT diagnostic functionality request. In response to recognizing the remotely-issued ONT diagnostic functionality request as being a request for implementing non-supported ONT diagnostic functionality, the PISF module 164 of the ONT 120 and the DISF module 170 of the ONT 120 jointly perform an operation 220 for communicating the remotely-issued ONT diagnostic functionality request from the PISF module 164 of the ONT 120 to the DISF module 170 of the ONT 120. In response to the remotely-issued ONT diagnostic functionality request being communicated to the DISF module 170 of the ONT 120, the DISF module 170 of the ONT 120 performs an operation 222 for recognizing the remotely-issued ONT diagnostic functionality request.

In response to recognizing the remotely-issued ONT diagnostic functionality request as being a request for implementing non-supported ONT diagnostic functionality, the DISF module 170 of the ONT 120 performs an operation 224 for interpreting the remotely-issued ONT diagnostic functionality request for determining specific details regarding the requested ONT diagnostic functionality (e.g., what ONT diagnostic functionality is being requested, under what conditions to perform the requested ONT diagnostic functionality, etc), followed by an operation 226 being performed for issuing an ONT diagnostic functionality request corresponding to the determined specific details (i.e., a locally-issued ONT diagnostic functionality request). The locally-issued ONT diagnostic functionality request is issued by the DISF module 170 for reception by the PISF module 164 of the ONT 120, the CPF module 166 of the ONT 120 and/or the TISF module 168 of the ONT 120, and is interpretable by such modules of the ONT 120.

After issuing the locally-issued ONT diagnostic functionality request and after the modules (164-170) of the ONT 120 act on the Locally-issued ONT diagnostic functionality request, the DISF module 170 performs an operation 228 for receiving diagnostic response information from the PISF module 164 of the ONT 120, the CPF module 166 of the ONT 120 and/or the TISF module 168 of the ONT 120. The diagnostic response information corresponds to a diagnostic result of the requested ONT diagnostic functionality (i.e., information resulting from the requested ONT diagnostic functionality being facilitated). In response to receiving the diagnostic response information, the DISF module 170 performs an operation 230 for preparing request reply information comprising at least a portion of the diagnostic response information. In response to preparing the request reply information, the PISF module 164 and the DISF module 170 jointly perform an operation 232 for communicating the request reply information from the DISF module 170 of the ONT 120 to the PISF module 164 of the ONT 120.

In response to the request reply information being communicated to the PISF module 164 of the ONT 120, the PISF module 164 of the ONT 120 performs an operation 234 for recognizing the request reply information. Such recognition in the upstream direction (i.e., toward the EMS 105) is disclosed herein to be recognition that the request reply information corresponds to non-supported ONT diagnostic functionality and thus must be interpreted, communicated, transmitted and/or received in accordance with the inventive disclosures made herein. For example, in one embodiment, the step of recognizing the request reply information includes determining whether the request reply information comprises particular identifying information, which designates the request reply information as being information associated with a request for implementing non-supported ONT diagnostic functionality. In response to recognizing the request reply information as being information associated with a request for implementing non-supported ONT diagnostic functionality, the PISF module 164 of the ONT 120 performs an operation 236 for transmitting the request reply information from the ONT 110 for reception by the OLT 110 over the PON 115. In one embodiment, transmitting the request reply information preferably includes generating one or more command packets corresponding to the request reply information and being configured for transmission over the PON 115.

Referring to FIG. 4C, the PISF module 154 of the OLT 110 performs an operation 238 for receiving the request reply information, which was transmitted from the OLT 110 for reception by the ONT 120. In response to receiving the request reply information, the PISF module 154 of the OLT 110 performs an operation 240 for recognizing the remotely-issued ONT diagnostic functionality request. In response to recognizing the request reply information as being information associated with a request for implementing non-supported. ONT diagnostic functionality, the PISF module 154 of the OLT 110 and the DISF module 156 of the OLT 110 jointly perform an operation 242 for communicating the request reply information from the PISF module 144 of the OLT 110 to the DISF module 156 of the OLT 110.

In response to the request reply information being communicated to the DISF module 156 of the OLT 120, the DISF module 156 of the OLT 110 performs an operation 244 for recognizing the request reply information. In response to recognizing the request reply information as being information associated with a request for implementing non-supported ONT diagnostic functionality, the DISF module 156 of the OLT 110 and the EMISF module 150 of the OLT 110 jointly perform an operation 246 for communicating the request reply information from the DISF module 156 of the OLT 110 to the EMISF module 150 of the OLT 110. In response to the request reply information being communicated to the EMISF module 150 of the OLT 110, the EMISF module 150 of the OLT 110 performs an operation 248 for recognizing the request reply information, followed by the EMISF module 150 of the OLT 120 performing an operation 250 for transmitting the request reply information for the OLT 110 for reception by the EMS 105.

Alternatively, the remotely-issued ONT diagnostic functionality request may be provided at the OLT local craft interface 162 by a craftsperson rather than being provided from the EMS 105. Similarly, the request reply information may be accessed by a craftsperson via the OLT local craft interface 162 rather than at the EMS 105.

In view of the method 200, a mechanism is provided for enabling a craftsperson to access diagnostic capabilities of the local craft interface 135 of the ONT 120 (i.e., the diagnostic interface of the ONT 120) without being present at the physical location of the ONT 120. This eliminates the need to travel to the physical location of the ONT 120 to do diagnostic tests that would otherwise require physical connectivity to the ONT 120. As depicted in the method 200, implementing such remote access to the diagnostic capabilities of a local craft interface of an ONT requires a number of distinguishing alterations and/or additions to the capabilities of the ONMT and an associated OLT. These alterations and/or additions include, but are not limited to, adding capabilities to the OLT to incorporate ONT diagnostic requests from the remote craftsperson into the information (e.g., data) that is exchanged between the OLT and the ONT over the PON, extending the capabilities to the protocol utilized on the PON to transfer diagnostic interactions between the remote craftsperson and the OLT, extending the capabilities to the protocol utilized on the PON to transfer diagnostic interactions between the remote craftsperson and the ONT, and extending the functionality of the various modules of the OLT and ONT such that requests for diagnostic actions by the remote craftsperson can be processed by the ONT as if they were issued at the local craft interface of the ONT.

Extension of the ONT/OLT interfaces would involve extending the Physical Layer OAM (PLOAM) and/or OMCI protocol utilized in BPON (broadband PON) systems. For GPON (gigabit PON) and EPON (Ethernet-based PON) systems, the corresponding protocol components would require extension. The extension of the PLOAM (or lowest corresponding level in GPON or EPON systems) level of the interface protocol would maximize the diagnostic value of the inventive disclosures made herein because dependencies on high-level functionality would be minimized. Extension of the OMCI, or corresponding protocols in GPON and EPON systems is also possible and, in some instances, would provide a similar level of diagnostic capabilities.

PLOAM is a Layer 2 protocol for exchanging packets of management information between the OLT and ONT. OMCI is the management channel protocol. Implementation of methods and systems in accordance with the inventive disclosures made herein involves either extending the PLOAM transfer mechanism to support the exchange of messages between the processors of an OLT and an ONT, or utilization of the user defined message capability of OMCI to transfer this same information. Utilization of PLOAM is preferred, as this strategy would put the least amount of software between the remote craftsperson and processing device(s) of the ONT. However, Utilization of the PLOAM involves an extension of the associated interface protocol. Using the user-defined messages in OMCI would have a smaller standardization impact but would be less robust because of the involvement of more protocol software between processors of the OLT and ONT. Regardless of the chosen approach, the resulting mechanism must enable exchange of message packets between the ONT and the OLT containing vendor specific (e.g., proprietary) commands and the corresponding response data.

Referring now to computer readable medium, it will be understood from the inventive disclosures made herein that methods, processes and/or operations adapted for carrying out ONT diagnostic functionality as disclosed herein are tangibly embodied by computer readable medium having instructions thereon for carrying out such functionality. In one specific embodiment, the instructions are tangibly embodied for carrying out the method 200 disclosed above in FIGS. 3A though 3C to facilitate requested ONT diagnostic functionality that is proprietary and not supported (i.e., non supported ONT diagnostic functionality) by PON interface capabilities of the ONT. The instructions may be accessible by one or more data processing devices from a memory apparatus (e.g. RAM, ROM, virtual memory, hard drive memory, etc), from an apparatus readable by a drive unit of a data processing system (e.g., a diskette, a compact disk, a tape cartridge, etc) or both. Accordingly, embodiments of computer readable medium in accordance with the inventive disclosures made herein include a compact disk, a hard drive, RAM or other type of storage apparatus that has imaged thereon a computer program (i.e., a set of instructions) adapted for carrying out ONT diagnostic functionality in accordance with the inventive disclosures made herein.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical, mechanical and electrical changes may be made without departing from the spirit or scope of the invention. For example, functional blocks shown in the figures could be further combined or divided in any manner without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An Optical Network Terminal (ONT) for a Passive Optical Network (PON) system, comprising:
a Diagnostic Interface Support Functions (DISF) module; and
a PON Interface Support Functions (PISF) module connected to the DISF module;
wherein the PISF module is configured for receiving a remotely-issued diagnostic request transmitted for reception by the PISF module over a PON connected to the PISF module and for transmitting request reply information over the PON from the PISF module in response to the PISF module receiving said request reply information from the DISF module; and
wherein the DISF module and the PISF module are jointly configured for enabling the remotely-issued diagnostic request to be communicated from the PISF module to the DISF module and for enabling said request reply information to be communicated from the DISF module to the PISF module.

2. The Optical Network Terminal of claim 1, further comprising:
a Core Processing Functions (CPF) module; and
a Telephony Interface Support Functions (TISF) module;
wherein said modules are jointly configured for enabling a locally-issued diagnostic request corresponding to the remotely-issued diagnostic request to be communicated from the DISF module to at least one of the CPF module, the PISF module and the TISF module in response to the DISF module receiving the remotely-issued diagnostic request.

3. The Optical Network Terminal of claim 2 wherein:
said modules are configured for enabling ONT diagnostic functionality corresponding to the remotely-issued diagnostic functionality request to be facilitated and for generating diagnostic response information in response to facilitating said ONT diagnostic functionality;
said ONT diagnostic functionality is facilitated in response to the locally-issued diagnostic request being communicated from the DISF module to at least one of the CPF module, the PISF module; and the TISF module;
said modules are jointly configured for enabling said diagnostic response information to be communicated from at least one of the CPF module, the PISF module and the TISF module to the DISF module; and
said request reply information corresponds to a diagnostic result comprised by said diagnostic response information.

4. The Optical Network Terminal of claim 1 wherein:
the PISF module is configured for recognizing the remotely-issued diagnostic request as being remotely issued and for communicating the remotely-issued diagnostic request from the PISF module to the DISF module in response to the PISF module recognizing the remotely-issued diagnostic request; and
the DISF module is configured for recognizing the remotely-issued diagnostic request as being remotely issued and for facilitating ONT functionality corresponding to the remotely-issued diagnostic request after the DISF module recognizes the remotely-issued diagnostic request.

5. The Optical Network Terminal of claim 4, further comprising:
a Core Processing Functions (CPF) module; and
a Telephony Interface Support Functions (TISF) module;
wherein said modules are jointly configured for enabling a locally-issued diagnostic request corresponding to the remotely-issued diagnostic request to be communicated from the DISF module to at least one of the CPF module, the PISF module and the TISF module in response to the DISF module receiving and recognizing the remotely-issued diagnostic request.

6. The Optical Network Terminal of claim 5 wherein:
said modules are configured for enabling ONT diagnostic functionality corresponding to the remotely-issued diagnostic request to be facilitated and for generating diagnostic response information in response to facilitating said ONT diagnostic functionality;
said ONT diagnostic functionality is facilitated in response to the locally-issued diagnostic request being communicated from the DISF module to at least one of the CPF module, the PISF module; and the TISF module;
said modules are jointly configured for enabling said diagnostic response information to be communicated from at least one of the CPF module, the PISF module and the TISF module to the DISF module; and
said request reply information corresponds to a diagnostic result comprised by said diagnostic response information.

7. A passive optical network system, comprising:
an Optical Network Terminal (ONT);
an Optical Line Terminal (OLT); and
a Passive Optical Network (PON) connected between the ONT and the OLT;
wherein the ONT and the OLT are jointly configured for enabling a remotely-issued diagnostic request to be communicated from the OLT to the ONT via the PON
wherein the ONT and the OLT are jointly configured for enabling request reply information to be communicated from the ONT to the OLT over the PON;
wherein the ONT and the OLT each include a Diagnostic Interface Support Functions (DISF) module and a PON Interface Support Functions (PISF) module;
wherein the DISF module of the OLT and the PISF module of the OLT are jointly configured for enabling the remotely-issued diagnostic request to be communicated from the DISF module of the OLT to the PISF module of the OLT and for enabling said request reply information to be communicated from the PISF module of the OLT to the DISF module of the OLT; and
wherein the DISF module of the ONT and the PISF module of the ONT are jointly configured for enabling the remotely-issued diagnostic request to be communicated from the PISF module of the ONT to the DISF module of the ONT and for enabling said request reply information to be communicated from the DISF module of the ONT to the PISF module of the ONT.

8. The passive optical network system of claim 7 wherein:
the ONT includes a Core Processing Functions (CPF) module and a Telephony Interface Support Functions (TISF) module;
said modules of the ONT are jointly configured for enabling a locally-issued diagnostic request corresponding to the remotely-issued diagnostic request to be communicated from the DISF module of the ONT to at least one of the CPF module, the PISF module of the ONT and the TISF module in response to the DISF module of the ONT receiving and recognizing the remotely-issued diagnostic request.

9. The passive optical network system of claim 8 wherein:
said modules of the ONT are jointly configured for enabling ONT diagnostic functionality corresponding to the remotely-issued diagnostic request to be facilitated and for generating diagnostic response information in response to facilitating said ONT diagnostic functionality;
said ONT diagnostic functionality is facilitated in response to the locally-issued diagnostic request being communicated from the DISF module of the ONT to at least one of the CPF module, the PISF module of the ONT and the TISF module;
said modules of the ONT are jointly configured for enabling said diagnostic response information to be communicated from at least one of the CPF module, the PISF module of the ONT and the TISF module to the DISF module of the ONT; and
said request reply information corresponds to a diagnostic result comprised by said diagnostic response information.

10. The passive optical network system of claim 7 wherein:
the DISF module of the OLT is configured for recognizing the remotely-issued diagnostic request as being remotely issued and for communicating the remotely-issued diagnostic request from the DISF module to the PISF module of the OLT in response to the DISF module of the OLT recognizing the remotely-issued diagnostic request;
the PISF module of the ONT is configured for recognizing the remotely-issued diagnostic request as being remotely issued and for communicating the remotely-issued diagnostic request from the PISF module to the DISF module of the ONT in response to the PISF module of the ONT recognizing the remotely-issued diagnostic request; and
the DISF module of the ONT is configured for recognizing the remotely-issued diagnostic request as being remotely issued and for facilitating ONT functionality corresponding to the remotely-issued diagnostic request after the DISF module of the ONT recognizes the remotely-issued diagnostic request.

11. The passive optical network system of claim 10 wherein:
the ONT includes a Core Processing Functions (CPF) module and a Telephony Interface Support Functions (TISF) module;
said modules of the ONT are jointly configured for enabling a locally-issued diagnostic request corresponding to the remotely-issued diagnostic request to be communicated from the DISF module of the ONT to at least one of the CPF module, the PISF module of the ONT and the TISF module in response to the DISF module of the ONT receiving and recognizing the remotely-issued diagnostic request.

12. The passive optical network system of claim 11 wherein:
said modules of the ONT are jointly configured for enabling ONT diagnostic functionality corresponding to the remotely-issued diagnostic request to be facilitated and for generating diagnostic response information in response to facilitating said ONT diagnostic functionality;
said ONT diagnostic functionality is facilitated in response to the locally-issued diagnostic request being communicated from the DISF module of the ONT to at least one of the CPF module, the PISF module of the ONT and the TISF module;
said modules of the ONT are jointly configured for enabling said diagnostic response information to be communicated from at least one of the CPF module, the PISF module of the ONT and the TISF module to the DISF module of the ONT; and
said request reply information corresponds to a diagnostic result comprised by said diagnostic response information.

13. The passive optical network system of claim 7 wherein:
the OLT includes an Element Management Interface Support Functions (EMISF) module;
the DISF module of the OLT and the EMISF module are jointly configured for enabling the remotely-issued diagnostic request to be communicated from the EMISF module to the DISF module of the OLT and for enabling said request reply information to be communicated from the DISF module of the OLT to the EMISF module.

14. A method for facilitating remote access of Optical Network Terminal (ONT) functionalities in a Passive Optical Network (PON) system, comprising:
receiving a remotely-issued diagnostic request transmitted for reception by a PON Interface Support Function (PISF) module of an ONT over a PON connected to the PISF;
communicating the remotely-issued diagnostic request from the PISF module to a Diagnostic Interface Support Functions (DISF) module of the ONT;
communicating request reply information from the DISF module to the PISF module; and
transmitting said request reply information over the PON from the PISF module in response to the PISF module receiving said request reply information from the DISF module.

15. The method of claim 14, further comprising:
communicating a locally-issued diagnostic request corresponding to the remotely-issued diagnostic request from the DISF module to at least one of a Core Processing Functions (CPF) module of the ONT, the PISF module and a Telephony Interface Support Functions (TISF) module of the ONT in response to the DISF module receiving the remotely-issued diagnostic request.

16. The method of claim 15, further comprising:
facilitating ONT diagnostic functionality corresponding to the remotely-issued diagnostic request in response to the locally-issued diagnostic request being communicated from the DISF module to at least one of the CPF module, the PISF module; and the TISF module; and
generating diagnostic response information in response to facilitating said ONT diagnostic functionality;
communicating said diagnostic response information from at least one of the CPF module, the PISF module and the TISF module to the DISF module, wherein said request reply information corresponds to a diagnostic result comprised by said diagnostic response information.

17. The method of claim 14, further comprising:
recognizing the remotely-issued diagnostic request as being remotely issued;
communicating the remotely-issued diagnostic request from the PISF module to the DISF module in response to the PISF module recognizing the remotely-issued diagnostic request;
facilitating ONT diagnostic functionality corresponding to the remotely-issued diagnostic request after the DISF module recognizes the remotely-issued diagnostic request; and
communicating said diagnostic response information from at least one of the CPF module, the PISF module and the TISF module to the DISF module, wherein said request reply information corresponds to a diagnostic result comprised by said diagnostic response information.

18. The method of claim 17, further comprising:
communicating a locally-issued diagnostic request corresponding to the remotely-issued diagnostic request from the DISF module to at least one of a Core Processing Functions (CPF) module of the ONT, the PISF module and a Telephony Interface Support Functions (TISF) module of the ONT in response to the DISF module receiving and recognizing the remotely-issued diagnostic request;
facilitating said ONT diagnostic functionality corresponding to the remotely-issued diagnostic request in response to the locally-issued diagnostic request being communicated from the DISF module to at least one of the CPF module, the PISF module; and the TISF module; and
generating diagnostic response information in response to facilitating said ONT diagnostic functionality;
communicating said diagnostic response information from at least one of the CPF module, the PISF module and the TISF module to the DISF module, wherein said request reply information corresponds to a diagnostic result comprised by said diagnostic response information.
